(19) United States
(12) Patent Application Publication
(10) Pub. No.: US 2004/0129044 A1
(43) Pub. Date: Jul. 8, 2004

(54) Multifunction lock cylinder

(76) Inventor: Thomas J. DiVito, Southington, CT (US)

Correspondence Address: Alix Yale & Ristas, 750 Main Street, Hartford, CT, 06103-2721, US

(21) Appl. No.: 10/469,946

(22) PCT Filed: Mar. 7, 2002
(86) PCT No.: PCT/US02/07151

(51) Int. Cl. E05B 47/06

(52) U.S. Cl. 70/278.3

(57) ABSTRACT

A cylinder lock device (10) for mounting to a security compartment (41), wherein the improvement comprises that the cylinder can be configured by the end user to permit opening of the compartment by at least two of the group of functional operations consisting of turnknob, mechanical key, and electronic key. The cylinder comprises a plug (11), a shell (12) surrounding the plug and defining a first shear line (36) therebetween, and a housing (17) surrounding the shell and defining a second shear line (35) therebetween. One configuration fixes the first shear line to prevent relative rotation between the plug and the shell while permitting rotation of the plug and shell together relative to the housing along the second shear line. Another configuration fixes the second shear line to prevent relative rotation between the shell and the housing while permitting rotation of the plug relative to the shell along the first shear line.

### BACKGROUND

The present invention relates to locking devices, and more particularly to high security cylinder locks.

In any activity involving the collection or storage of valuable tangibles, such as money, medications, jewels and the like, security beyond a simple lock and key is required. Compartments where such items are collected or stored can be found in the gaming industry, parking meters, vending machines, medicine cabinets, and the like. Locks that restrict access to such compartments must be resistant to tampering and to unauthorized persons who may have gained possession of one key that fits the lock. Thus, lock systems having diverse functionality are typically employed in this context. This diverse functionality is implemented by a plurality of independent lock devices, operated by independent actuators. Only authorized personnel have the means to actuate all of the plurality of locking devices. The need for independent locking devices has a significant cost consequence in that different locking devices must be selected, ordered, installed, and maintained.

### SUMMARY OF THE INVENTION

With the present invention, the security of diverse, independent actuators is preserved, but the cost of independent locking devices is reduced considerably. According to the invention, a single locking cylinder mountable on the compartment can be configured to provide multiple functionality responsive to multiple, diverse, independent actuators.

In particular, the invention is directed to a cylinder lock device for mounting to a security compartment, wherein the improvement comprises that the cylinder can be configured by the end user to permit opening of the compartment by at least two of the group of functional operations consisting of turnknob, mechanical key, and electronic key. Preferably, the cylinder can be configured by the end user to permit opening of the compartment by three functional operations consisting of turnknob, mechanical key, and electronic key.

In the embodiments to be described in greater detail below, the cylinder comprises an elongated plug, a shell surrounding the plug and defining a first shear line therebetween, and a housing surrounding the shell and defining a second shear line therebetween. One configuration fixes the first shear line to prevent relative rotation between the plug and the shell while permitting rotation of the plug and shell together relative to the housing along the second shear line. Another configuration fixes the second shear line to prevent relative rotation between the shell and the housing while permitting rotation of the plug relative to the shell along the first shear line.

In the currently preferred but not exclusive embodiment, the invention comprises a locking system having:

(a) a cylinder having an outer shell with front and back ends, a plug disposed longitudinally within the shell and selectively rotatable within the shell, a keyhole at the front end leading into a keyway that extends longitudinally into the plug, and a plurality of pins, each radially displaceable between a locking position and a cleared position, whereby when all pins are in the cleared position the plug is free to rotate within the shell but when at least one pin is in the locking position the plug is prevented from rotating relative to the shell;

(b) a key having a bow for holding in the fingers and a shank extending from the bow, the shank sized and shaped to pass through the keyhhole into the keyway, and having formations thereon for contacting a subset of the pins in the cylinder, to displace said subset from the locking to the cleared position as the key fully engages the keyway;

(c) a latch operatively connected to the plug such that when the plug rotates relative to the shell, the latch is displaced between a latching position for engaging a hook within the compartment, and an unlatching position for disengaging from the hook;

(d) means for mounting the cylinder to the compartment so that the front end of the cylinder is outside the compartment and the back end of the cylinder and the latch are inside the compartment;

(e) a first security passage radially penetrating the shell inside the compartment and leading to one of said pins that is not in the subset engagable by the key formations;

(f) a second security passage into said shell and leading to another of said pins that is not in the subset engagable by the key formations;

(g) a first security actuator sized and shaped to enter the first security passage and displace said one pin to a cleared position;

(h) a second security actuator sized and shaped to enter the second security passage and displace said another pin to a cleared position;

whereby when the key is fully engaged in the keyway and both security actuators have displaced their respective pins to the cleared position, the key can rotate the plug and thereby displace the latch.

Some of the specific new features available in combination according to the present invention include:

Removal turnknob for electronic cylinder.

Cylinder screw to convert turnknob into mechanical cylinder.

Removable turnknob for a mechanical key (without key bitting).

Cylinder that can be converted from mechanical only to mechanical or electronic (by adding the solenoid).

Cylinder that can be converted from mechanical only to mechanical and electronic (by adding the solenoid and screw).

Electronic cylinder with mechanical key override by using a second shear line.

Electronic cylinder that can be opened mechanically by pushing solenoid out with mechanical tool (key or other means).

Electronic and mechanical cylinder that can be opened with a special mechanical key that pushes the solenoid out.

Electronic cylinder as above that can be opened with power from the key or machine.

Electronic cylinder as above that ties into existing communication network or through the key.

Holding pin to stop rotation of secondary shear line.

### BRIEF DESCRIPTION OF THE DRAWINGS

Many embodiments and variations of the invention can be ascertained by practitioners in the field of security lock design and manufacture, based on the following detailed description with associated drawings, in which

FIG. 1 is a longitudinal section view of the turnknob embodiment of the invention;

FIGS. 2A and 2B are longitudinal section views of the mechanical cylinder embodiment;

FIGS. 3A, B, C and D are longitudinal section views of the electronic cylinder with mechanical override (2^{nd} shear line) embodiment;

FIGS. 4A, B, C and D are longitudinal section views of the electronic cylinder with mechanical override (keyway) embodiment;

FIGS. 5A, B and C are longitudinal section views of the mechanical cylinder with electronic override embodiment;

FIGS. 6A and 6B are longitudinal section views of the mechatronic cylinder (both electronic and mechanical) with no override embodiment;

FIGS. 7A, B and C are longitudinal section views of the mechatronic cylinder with mechanical override (keyway) embodiment;

FIGS. 8A, B and C are longitudinal section views of the dummy turnknob with mechanical override embodiment;

FIGS. 9A, B and C are longitudinal section views of the turnknob convertible to mechanical embodiment;

FIGS. 10A, B and C are longitudinal section views of the turnknob convertible to mechanical embodiment;

FIGS. 11A, B, C and D are longitudinal section views of the electronic cylinder with mechanical override (2^{nd} shear line) embodiment;

FIGS. 12A B, C and D are longitudinal section views of the alternative electronic with mechanical override (2^{nd} shear line) embodiment; and

FIGS. 13A and B are longitudinal section views of the mechatronic cylinder with cam retainer embodiment.

### DESCRIPTION OF THE PREFERRED EMBODIMENTS

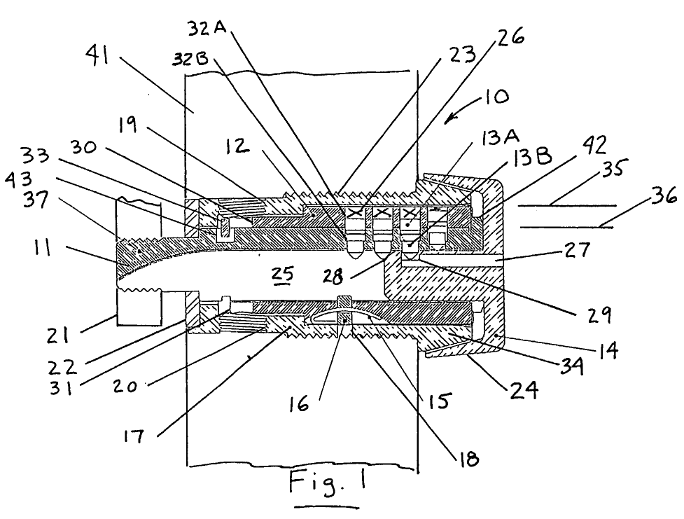

FIG. 1 shows a cylinder lock device 10, comprising a central plug 11, a substantially tubular shell 12 surrounding an axial portion of the plug 11, and a substantially tubular housing 17. The shell 12 directly encircles the forward portion of the plug 11, whereas the housing 17 directly encircles the shell 12 and a rearward portion of the plug 11 (without the intervening presence of the shell 12). As oriented in FIG. 1, the locking cylinder device 10 has a front side at the right, accessible from outside the container, and a back side at the left, extending into the container.

Functions

1. Turnknob Function

FIG. 1 shows a turn knob configuration, whereby the plug 11 is locked to the shell 12 by the spring loaded tumbler pins 13. In particular, each tumbler set has a drive portion 13A abutting a driven portion 13B, for movement within bores 32A in the shell 12 and 32B in the plug 11. Springs 26 in the bores 32A urge the tumblers 13A against 13B, whereby in the absence of a key in the keyway 25, the default location of the interface between tumbler parts 13A and 13B, is within the plug 11. Thus, the tumbler portions 13A span the shear line 36 between plug 11 and shell 12, preventing relative rotation therebetween.

A holding pin 16 is situated in an aperture in the shell 12 and biased by a spring 15 acting between the shell 12 and the housing 17, so as to project within the keyway 25 to prevent relative rotation between the plug 11 and the shell 12. The housing 17 has an aperture or recess 18 such that, under circumstances to be described below, the holding pin 16 can be retracted from the keyway and thereby also clear the shear line 36 between the shell 12 and plug 11, around the entire circumference of the plug 11.

The turnknob 14 preferably has the outer configuration of a cup or the like, with a circular front face and an annular rim or the like 24 that conforms in shape to an annular flange or the like 34 on the forward end of the housing 17. The turn knob has a central projection adapted to enter the keyway 25, with a nose portion that is beveled or the like at 28 for radially displacing at least some of the tumblers 13, such that at least one of the displaced tumblers can ride over the nose 28 during insertion of the projection and return to the default position, (e.g., as a detent), within a recess 29 in the turn knob projection.

In this configuration, the turn knob 14 can be manually rotated by grasping the rim portion 24, which rotates the plug 11 and shell 12 as an assembly, along the shear line 35 between housing 17 and shell 12, relative to the stationary housing 17. In particular, the turn knob has an interference engagement with the plug 11 via the detent relationship between the tumbler pin 13 and the recess 29, and the plug 11 has an interference relationship with shell 12, via the holding pin 16 and the tumblers 13A crossing shear line 36.

It is well known that for a cam lock, the plug 11 may have a threaded projection 37 onto which a cam or similar member 21 can be secured, for rotation to effectuate a desired locking of the door 41. The cylinder device 10 would be mounted to the door or container, for example, via external threads 23 on the housing 17. The inside of the door or container would typically have structure for interacting with the cam 21.

Although the cylinder lock 10 according to the invention can take a variety of forms, in the illustrated embodiment the front extremity is defined by a flanged portion 42 of the plug 11. At the rear, a washer or ring 22 is press fit over plug projection 37 or otherwise secured relative to housing 17. The ring 22 is used to restrict rotation of the cam and provide a house (key pull-out) position. The housing 17, shell 12, and plug 11 are nested to prevent relative axial displacement using shoulders, notches or the like in a manner that can be readily discernable and varied by practitioners in this field of technology.

The turnknob function does not provide security and is typically utilized in conjunction with secondary electronic locking via a solenoid through access bores 31 or 32 or is used as a convenience opening during installation or repair. After installation, the installer can insert a pin or the like through bore 27, which extends from the exposed front of the turnknob 14, through the portion projecting into the keyway, to the recess 29, whereby the tumbler pin 13 therein can be displaced radially outwardly a sufficient distance to permit passage of nose 28 and withdrawal and removal of the turn knob.

2. Mechanical Lock Function

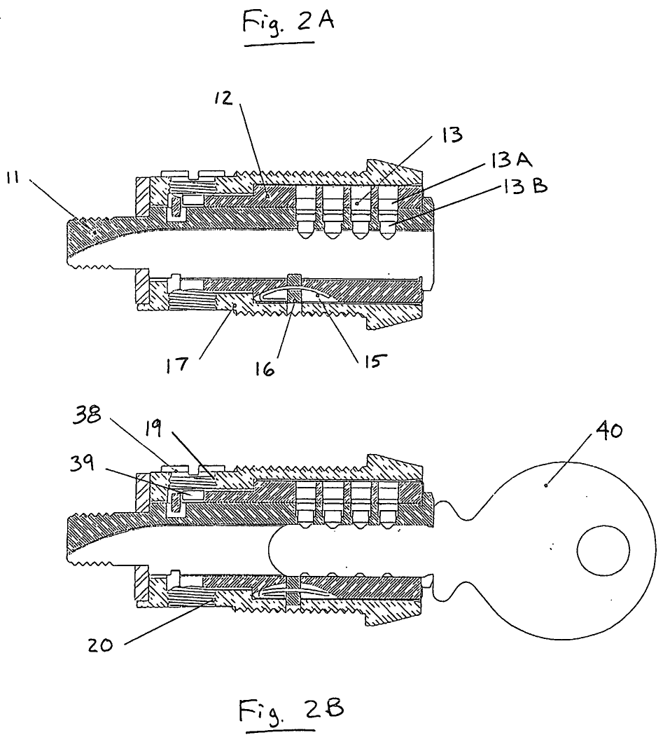

A first operational configuration as a mechanical cylinder for a cam lock style device, is shown in FIGS. 2A and 2B (with reference to FIG. 1 as well). In this function, the plug 11 is locked to the shell 12 via the spring-loaded tumbler pins 13. The shell 12 is prevented from rotating in housing 17 by means of a set screw 38 that can be inserted in either one of the diametrically opposed threaded bores 19, 20 in shell 17. Such screw 38 has a nose portion 39 that enters a corresponding recess or bore 30. Bore 31 is for a solenoid. If no screw in 30, an extended key with any bitting will depress solenoid and allow rotation of plug/shell assembly. If screw is present, the longer key must be bitted with proper code to allow plug rotation in the shell 12, thereby establishing an interference engagement with respect to relative rotation. The cylinder is operated by inserting a key 40, having proper bitting such that the tumbler portions 13B are driven upwardly and the interface between each portion 13A, 13B of each tumbler is at the shear line 36 between the plug 11 and shell 12. The front portion of the key blade also depresses the holding pin 16, thereby retracting it from the keyway and clearing the shear line between the plug 11 and shell 12, on the side of the key blade opposite to the tumblers 13. The shell 12 cannot rotate relative to the stationary housing 17, but the plug 11 can rotate relative to both the shell 12 and housing 17, thereby driving the cam 21. E-ring 33 retains plug 11 inside shell 12, via plug groove 43 for receiving the E-ring just behind the back of the shell.

3. Electronic with Mechanical Override (2^{nd} Shear Line)

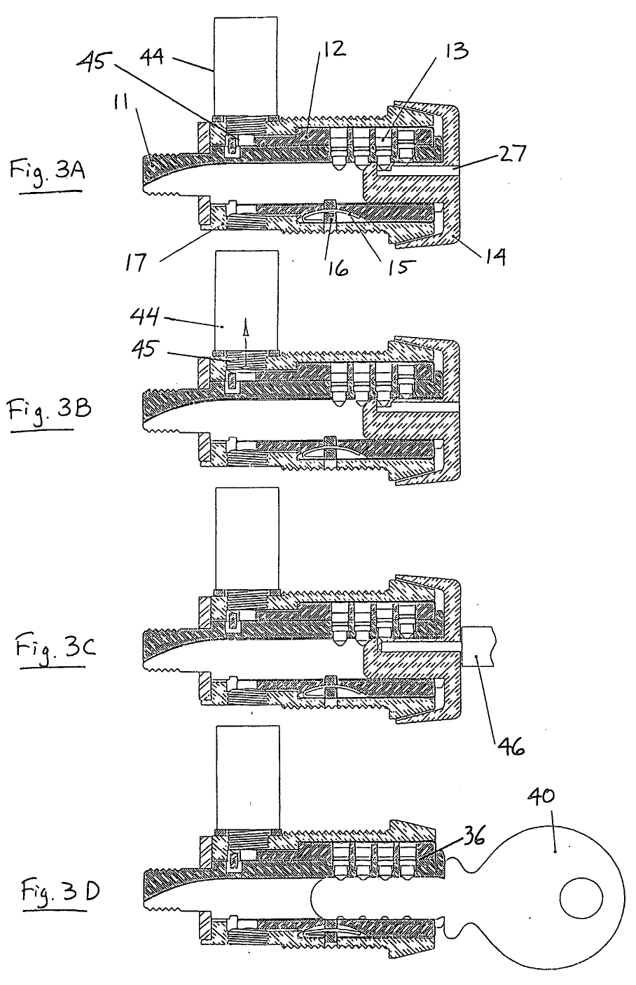

In this function, shown in FIGS. 3A-D, the plug 11 is locked to the shell 12 via the spring-loaded tumbler pins 13. The turnknob 14 is trapped in place by the tumbler pins. Holding pin 16 is disengaged from housing 17 by spring 15. Shell 12 is prevented from rotating in housing 17 by means of an electronic locking pin 44 that has been threaded into bore 19. The cylinder is operated when authorized power is sent to retractable electronic locking pin nose 45 and turnknob 14 is rotated. Plug 11 and shell 12 are rotated together, which drives a cam (not shown) on the protruding end of the plug.

To mechanically override the electronic locking pin, a turnknob removal tool 46 is inserted into bore 27 in turnknob 14, which lifts tumbler pin 13 and allows turnknob 14 to be removed from plug 11. The mechanical key 40 is then inserted into plug 11, and displaces holding pin 16 into housing 17. This aligns the tumbler pins to the shear line 36 of plug 11 and shell 12. The plug is rotated, which drives the cam on the protruding end of plug 11.

4. Electronic with Mechanical Override (Keyway)

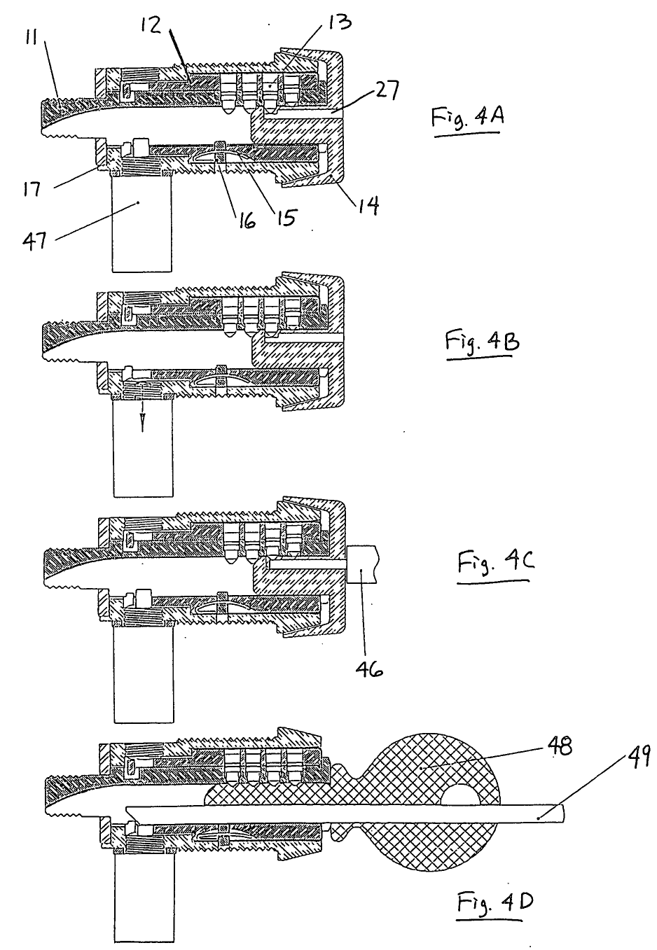

In this function, shown in FIGS. 4A-D, the plug 11 is locked to the shell 12 via the spring-loaded tumbler pins 13 and by electronic locking pin 8. The turnknob 4 is trapped in place by the tumbler pins 3. Holding pin 6 is disengaged from housing 7 by spring 5. The cylinder is operated when authorized power is sent to the retractable electronic locking pin 47. Turnknob 14 is rotated, which rotates plug 11 and shell 12 together in housing 17. A cam (not shown) on the protruding end of the plug is also rotated.

To mechanically override the electronic locking pin, turnknob a removal tool 46 is inserted into hole 27 in turnknob 4, which lifts tumbler pin 3 and allows turnknob 4 to be removed from plug 11. Mechanical key 48 having a longitudinal slot at the bottom of the blade is then inserted into plug 11, which engages holding pin 16 into housing 17 and aligns the tumbler pins to the shear line of plug 11 and shell 12. Override tool 49 is inserted into key 48, which depresses electronic locking pin 47. Key 48 is rotated, which in turn rotates plug 11. A cam (not shown) on protruding end of plug 11 is also rotated.

5. Mechanical with Electronic Override (2^{nd} Shear Line)

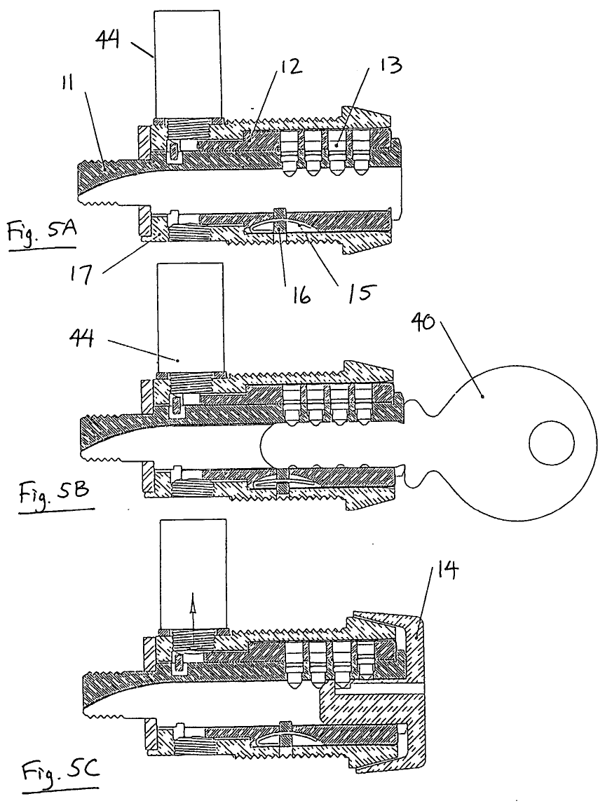

In this function, shown in FIGS. 5A-C, the plug 11 is locked to the shell 12 via the spring-loaded tumbler pins 13. Holding pin 16 is disengaged from housing 17 by spring 15. Shell 12 is prevented from rotating in housing 17 by means of electronic locking pin 44. The cylinder is operated by inserting mechanical key 40 into plug 11, which engages holding pin 16 into housing 17, and aligns the tumbler pins to the shear line of plug 11 and shell 12. The plug is rotated, which drives a cam (not shown) on protruding end of plug 11. To electronically override the mechanical locking, turnknob 14 is inserted into plug 11. When authorized power is sent to retract electronic locking pin 44, turnknob 14 is rotated. In turn, plug 11 and shell 12 are rotated together which drives the cam on the protruding end of plug.

6. Mechatronic—No Override

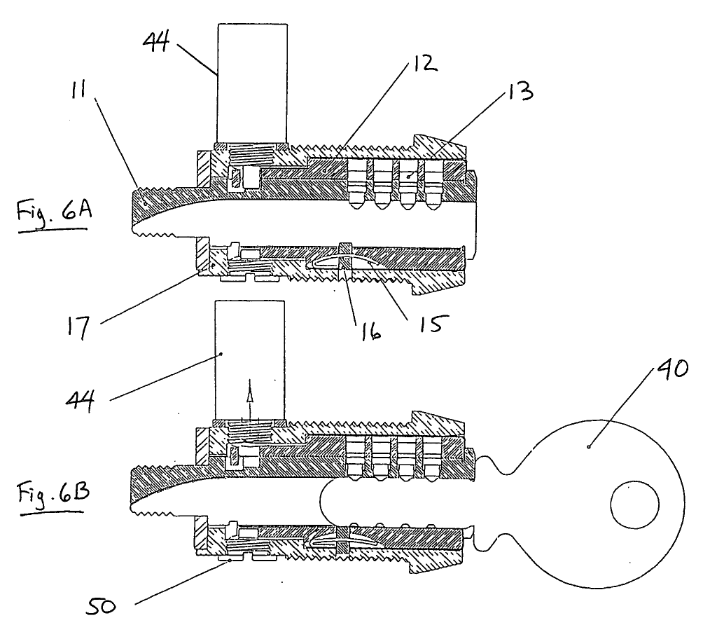

In this function, shown in FIGS. 6A and B, the plug 11 is locked to the shell 12 via spring-loaded tumbler pins 13, and the electronic locking pin 44. Holding pin 16 is disengaged from housing 17 by spring 15. Shell 12 is prevented from rotating in housing 17 by screw 50. The cylinder is operated when key 40 is inserted into plug 11, engaging holding pin 16 into housing 17 and aligning tumbler pins 13 with the shear line between plug 11 and shell 12. When authorized power is sent to retract electronic pin 44, key 40 can be rotated, which in turn, rotates plug 11 and the cam on the protruding end of plug 11.

7. Mechatronic with Mechanical Override (Keyway)

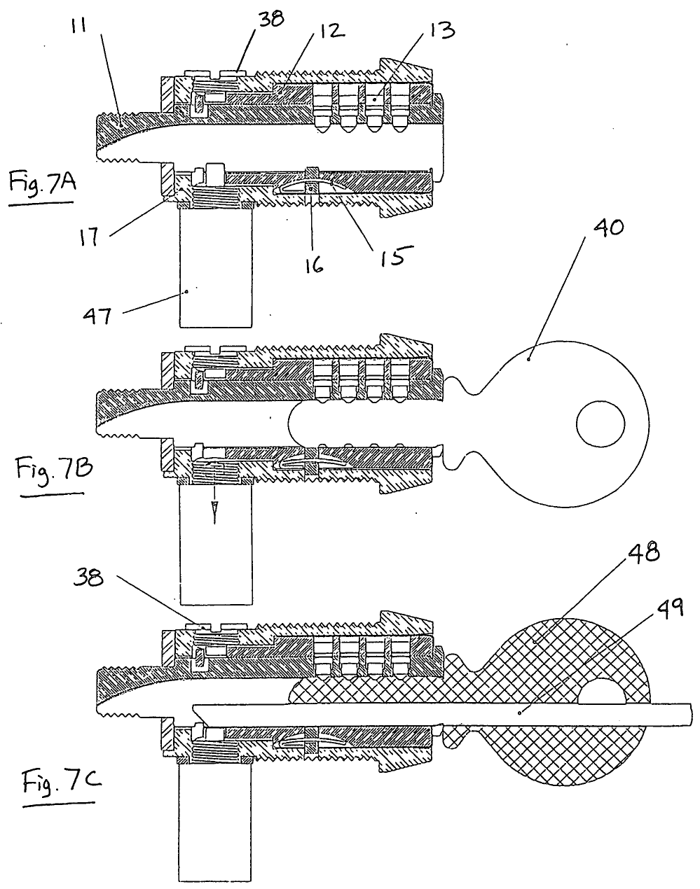

In this function, shown in FIGS. 7A-C, the plug 11 is locked to shell 12 via the spring-loaded tumbler pins 13 and the electronic locking pin 47 in the keyway. The shell 12 is prevented from rotating by screw 38. Holding pin 16 is disengaged from housing 17 by spring 15. The cylinder is operated by inserting operating key 40 into plug 11. This engages holding pin 16 into housing 17 and aligns tumbler pins 13 at the shear line of plug 11 and shell 12. When authorized power is sent to retract electronic locking pin 47, key 40 is rotated, which in turn, rotates plug 11 and the cam on the protruding end of plug 11.

To mechanically override the electronic locking pin 47, override key 48 is inserted into plug 11. This engages holding pin 16 into housing 17 and aligns tumbler pins 13 at the shear line of plug 11 and shell 12. Override tool 49 is inserted into operating key 48 to depress electronic locking pin 47. The override key 48 is rotated, which in turn rotates plug 11 and the cam on the protruding end of plug 11.

8. Dummy Turnknob with Mechanical Override

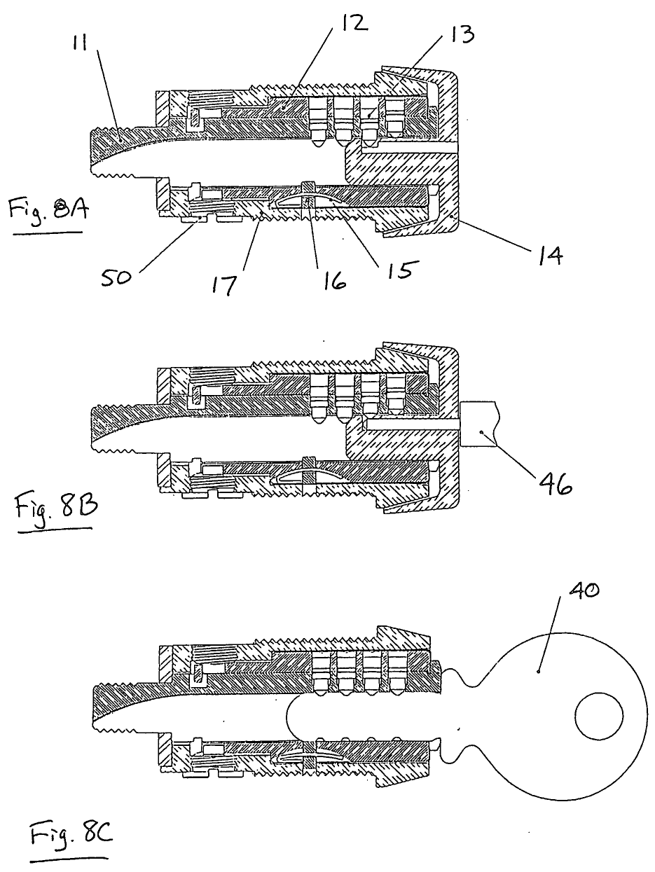

In this function, shown in FIGS. 8A-C, plug 11 is locked to shell 12 via the spring-loaded tumbler pins 13. Turnknob 14 is trapped in plug 11 by tumbler pins 13. Shell 12 is prevented from rotating in housing 17 by screw 50. Holding pin 16 is disengaged from housing 17 by spring 15. The cylinder does not function at this point. To mechanically override the cylinder, turnknob removal tool 46 is inserted into turnknob 14 which lifts tumbler pins 13 and allows removal of turnknob 14. Operating key 40 is inserted into plug 11. This engages holding pin 16 in housing 17 and aligns tumbler pins 3 at shear line of plug 1 and shell 2. Operating key 40 is rotated, which in turn, rotates plug 11 and the cam on the protruding end of plug 11.

9. Turnknob—Convertible to Mechanical (Shipping)

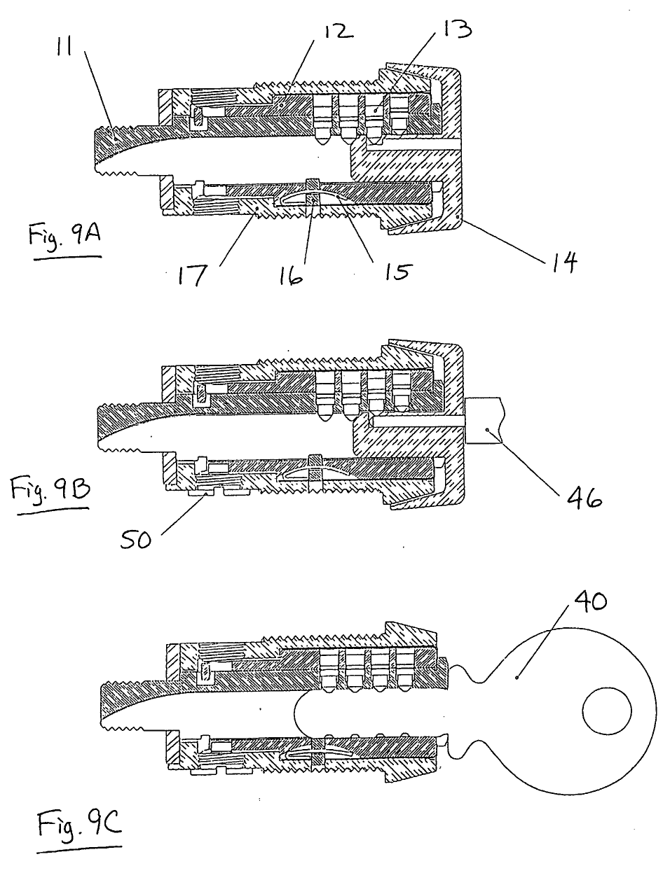

In this function, shown in FIGS. 9A-C, plug 11 is locked to shell 12 via the spring-loaded tumbler pins 13. Turnknob 14 is trapped in plug 11 by tumbler pins 13. Holding pin 16 is disengaged from housing 17 by spring 15. The cylinder is operated by rotating turnknob 14, which in turn rotates plug 11 and shell 12 together in housing 17. The cam on the protruding end of plug 11 would also be rotated.

To convert to mechanical, the turnknob removal tool 46 is inserted into turnknob 14 which lifts tumbler pins 13 and allows removal of turnknob 14. Screw 50 is installed to prevent the rotation of shell 12 in housing 17. The cylinder now operates by inserting operating key 40 into plug 11. This engages holding pin 16 in housing 17 and aligns tumbler pins 13 at shear line of plug 11 and shell 12. Operating key 40 is rotated, which in turn, rotates plug 11 and the cam on the protruding end of plug 11.

10. Turnknob—Convertible to Mechanical (Shipping)

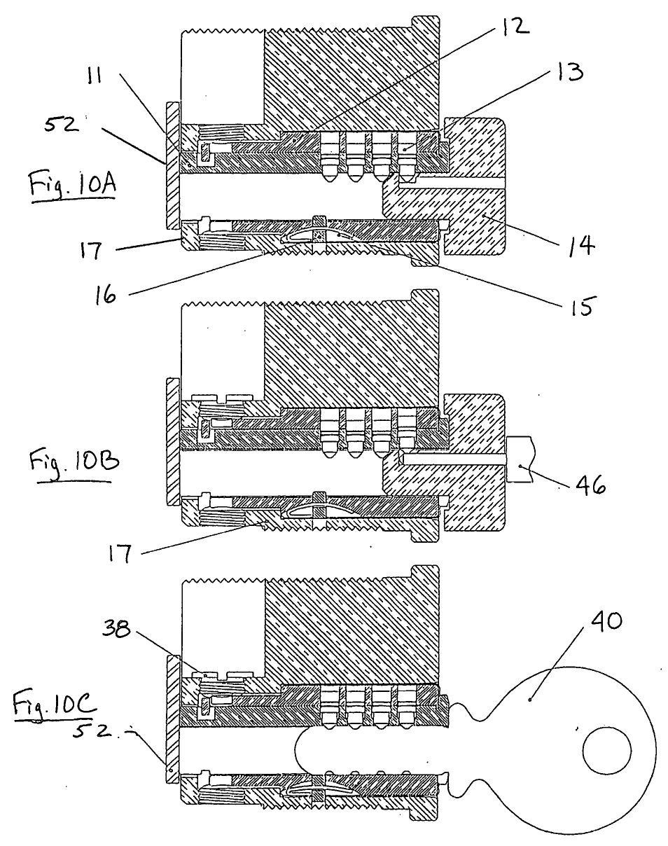

In this function, shown in FIG. 10A-C, plug 11 is locked to shell 12 via the spring-loaded tumbler pins 13. Turnknob 14 is trapped in plug 11 by tumbler pins 13. Holding pin 16 is disengaged from housing 17 by spring 15. The cylinder is operated by rotating turnknob 14, which in turn rotates plug 11 and shell 12 together in housing 17. The cam on the end of plug 11 would also be rotated.

To convert to mechanical, the turnknob removal tool 46 is inserted into turnknob 14 which lifts tumbler pins 13 and allows removal of turnknob 14. Screw 38 is installed to prevent the rotation of shell 12 in housing 17. The cylinder now operates by inserting operating key 40 into plug 11. This engages holding pin 16 in housing 17 and aligns tumbler pins 13 at shear line of plug 11 and shell 12. Operating key 40 is rotated, which in turn, rotates plug 11 and the cam 52 on the end of plug 11.

11. Electronic with Mechanical Override (2nd Shear Line)

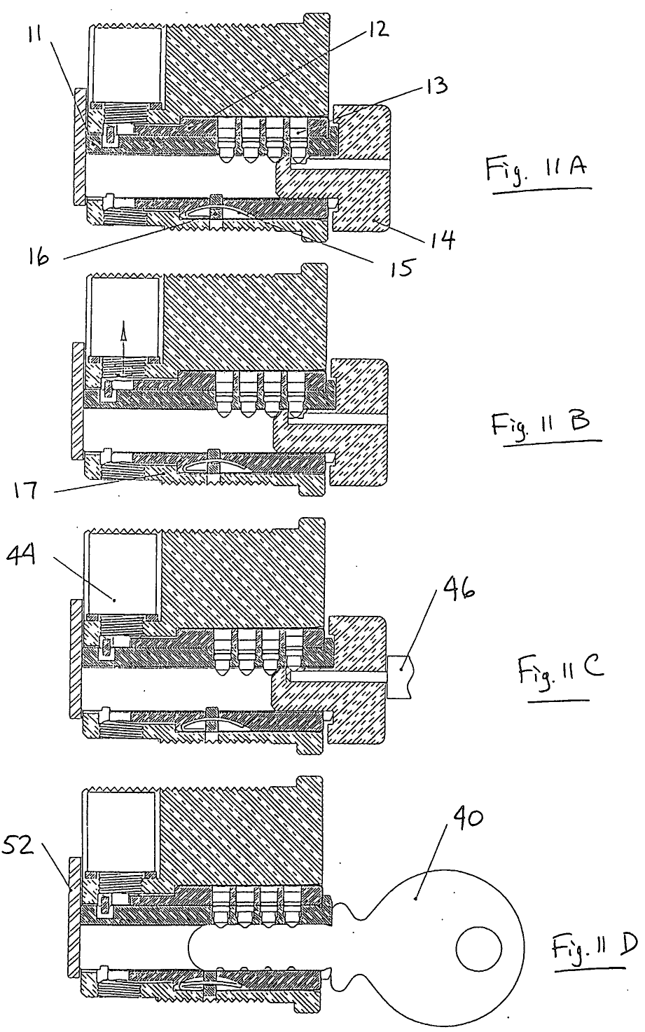

In this function, shown in FIGS. 11A-D, plug 11 is locked to shell 12 via the spring-loaded tumbler pins 13. The turnknob 14 is trapped in place by the tumbler pins. Holding pin 16 is disengaged from housing 17 by spring 15. Shell 12 is prevented from rotating in housing 17 by means of electronic locking pin 44. The cylinder is operated when authorized power is sent to retract electronic locking pin 44 and turnknob 14 is rotated. Plug 11 and shell 12 are rotated together which drives the cam on the end of the plug.

To mechanically override the electronic locking pin, turnknob removal tool 46 is inserted into hole in turnknob 14, which lifts tumbler pin 13 and allows turnknob 14 to be removed from plug 11. Mechanical key 40 is then inserted into plug 11, which engages holding pin 16 into housing 17 and aligns the tumbler pins to the shear line of plug 11 and shell 12. The plug is rotated which drives the cam on end of the plug 11.

12. Electronic with Mechanical Override (2^{nd} Shear Line)

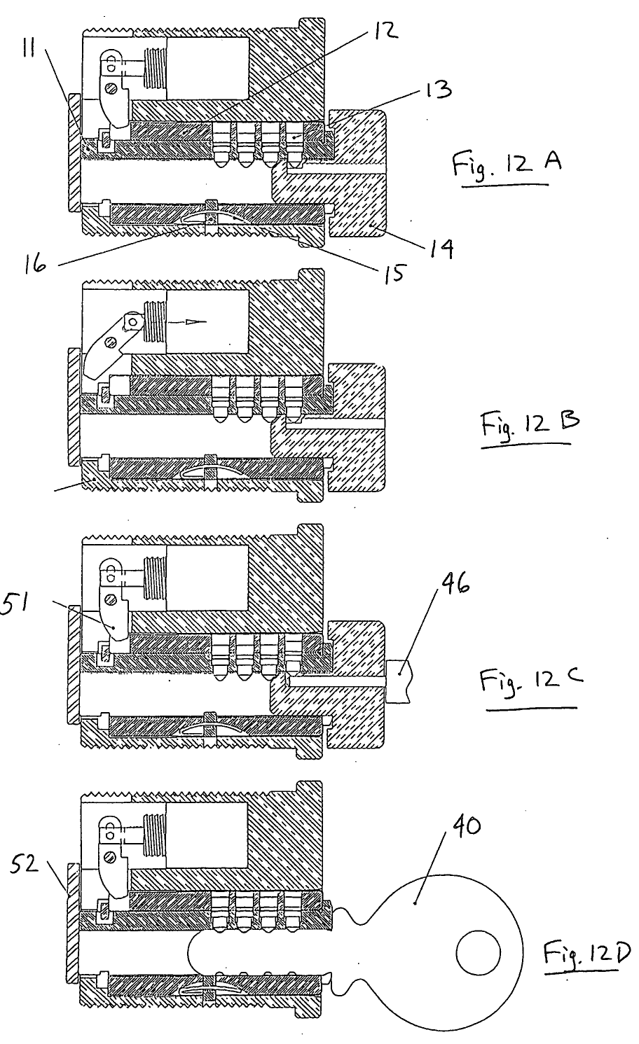

In this function, shown in FIGS. 12A-D, the plug 11 is locked to the shell 12 via the spring-loaded tumbler pins 13. The turnknob 14 is trapped in place by the tumbler pins. Holding pin 16 is disengaged from housing 17 by spring 15. Shell 12 is prevented from rotating in housing 17 by means of electronic locking lever 51. The cylinder is operated when authorized power is sent to retract electronic locking lever 51 and turnknob 14 is rotated. Plug 11 and shell 12 are rotated together which drives the cam on the end of the plug.

To mechanically override the electronic locking lever 51, turnknob removal tool 46 is inserted into hole in turnknob 14, which lifts tumbler pin 13 and allows turnknob 14 to be removed from plug 11. Mechanical key 40 is then inserted into plug 11, which engages holding pin 16 into housing 17 and aligns tumbler pins to the shear line of plug 11 and shell 12. The plug is rotated which drives the cam on the end of the plug.

13. Mechatronic Cylinder (cam locking version)

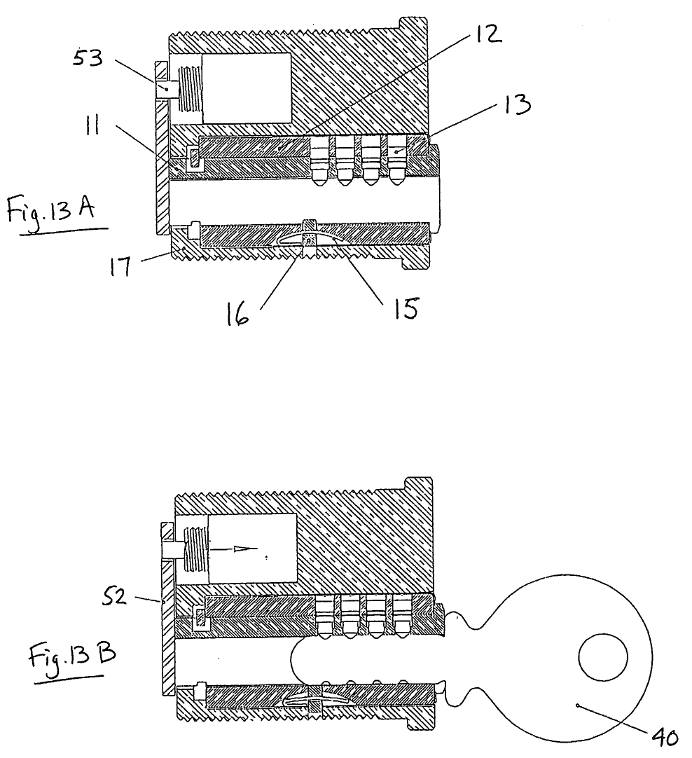

In this function, shown in FIGS. 13A and B, the plug 11 is locked to the shell 12 via the spring-loaded tumbler pins 13. Holding pin 16 is disengaged from housing 17 by spring 15. Cam 52 is prevented from rotating by means of electronic locking pin 53 which engages a hole in cam 52. The cylinder is operated when authorized power is sent to retract electronic locking pin 52 and operating key 40 is inserted into plug 11 which aligns tumbler pins 13 at the shear line between plug 11 and shell 12. Key 40 is rotated, which in turn, rotates cam 52 on end of plug 11.

General Configurability

Power for electronic communication may be provided from a key, as described in U.S. Pat. Nos. 5,423,198 or 5,771,722, or from a machine. Communication itself may come from a key or a machine.

All lock functions are contained in the cylinder and are field selectable. The following table summarizes some of the options:

| | TK | SK | OT | SC | SO | PO | CO |
|---|---|---|---|---|---|---|---|
| 1 | Y | N | N | N | N | N | N |
| 2 | N | Y | N | Y | N | N | N |
| 3 | Y | N | N | N | Y | Y | Y |
| 30 | N | Y | N | N | N | N | N |
| 4 | Y | N | N | N | Y | Y | Y |
| 40 | N | Y | Y | N | N | N | N |
| 5 | N | Y | N | N | N | N | N |
| 6 | N | Y | N | Y | Y | Y | Y |
| 7 | N | Y | N | Y | Y | Y | Y |
| 70 | N | Y | Y | Y | N | N | N |

Components:
TK—Turnknob and special removal tool or turning means (e.g., key)
SK—Short Key
OT—Override Tool
SC—Screw
SO—Solenoid (or other electric locking means)
PO—Power
CO—Communication

The resulting combination of features are highlighted in the foregoing Summary of the Invention.

1. A cylinder lock device for mounting to a security compartment, wherein the improvement comprises that the cylinder can be configured by the end user to permit opening of the compartment by at least two of the group of functional operations consisting of turnknob, mechanical key, and electronic key.

2. The cylinder lock of claim 1, wherein the cylinder can be configured by the end user to permit opening of the compartment by three functional operations consisting of turnknob, mechanical key, and electronic key.

3. The cylinder lock of claims 1 and 2, wherein
the cylinder comprises an elongated plug, a shell surrounding the plug and defining a first shear line therebetween, and a housing surrounding the shell and defining a second shear line therebetween, and
one configuration fixes the first shear line to prevent relative rotation between the plug and the shell while permitting rotation of the plug and shell together relative to the housing along the second shear line.

4. The cylinder lock of any of claims 1-3, wherein
the cylinder comprises an elongated plug, a shell surrounding the plug and defining a first shear line therebetween, and a housing surrounding the shell and defining a second shear line therebetween, and
one configuration fixes the second shear line to prevent relative rotation between the shell and the housing while permitting rotation of the plug relative to the shell along the first shear line

5. The cylinder lock of any of claims 1-4, for mounting to an access door for said security compartment, wherein
(a) the cylinder has an outer shell with front and back ends, a plug disposed longitudinally within the shell and selectively rotatable within shell, a keyhole at the front end leading into a keyway that extends longitudinally into the plug, and a plurality of pins, each radially displaceable between a locking position and a cleared position, whereby when all pins are in the cleared position the plug is free to rotate within the shell but when at least one pin is in the locking position the plug is prevented from rotating relative to the shell;
(b) a key having a bow for holding in the fingers and a shank extending from the bow, the shank sized and shaped to pass through the keyhhole into the keyway, and having formations thereon for contacting a subset of the pins in the cylinder, to displace said subset from the locking to the cleared position as the key fully engages the keyway;
(c) a latch operatively connected to the plug such that when the plug rotates relative to the shell, the latch is displaced between a latching position for engaging a hook within the compartment, and an unlatching position for disengaging from the hook;
(d) means for mounting the cylinder to the compartment so that the front end of the cylinder is outside the compartment and the back end of the cylinder and the latch are inside the compartment;
(e) a first security passage radially penetrating the shell inside the compartment and leading to one of said pins that is not in the subset engagable by the key formations;
(f) a second security passage into said shell and leading to another of said pins that is not in the subset engagable by the key formations;
(g) a first security actuator sized and shaped to enter the first security passage and displace said one pin to a cleared position;
(h) a second security actuator sized and shaped to enter the second security passage and displace said another pin to a cleared position;
(i) whereby when the key is fully engaged in the keyway and both security actuators have displaced their respective pins to the cleared position, the key can rotate the plug and thereby displace the latch.

6. A lock system for mounting to a security compartment having an access door, comprising:
(a) a cylinder having an outer shell with front and back ends, a plug disposed longitudinally within the shell and selectively rotatable within shell, a keyhole at the front end leading into a keyway that extends longitudinally into the plug, and a plurality of pins, each radially displaceable between a locking position and a cleared position, whereby when all pins are in the cleared position the plug is free to rotate within the shell but when at least one pin is in the locking position the plug is prevented from rotating relative to the shell;
(b) a key having a bow for holding in the fingers and a shank extending from the bow, the shank sized and shaped to pass through the keyhhole into the keyway, and having formations thereon for contacting a subset of the pins in the cylinder, to displace said subset from the locking to the cleared position as the key fully engages the keyway;
(c) a latch operatively connected to the plug such that when the plug rotates relative to the shell, the latch is displaced between a latching position for engaging a hook within the compartment, and an unlatching position for disengaging from the hook;
(d) means for mounting the cylinder to the compartment so that the front end of the cylinder is outside the compartment and the back end of the cylinder and the latch are inside the compartment;
(e) a first security passage radially penetrating the shell inside the compartment and leading to one of said pins that is not in the subset engagable by the key formations;
(f) a second security passage into said shell and leading to another of said pins that is not in the subset engagable by the key formations;
(g) a first security actuator sized and shaped to enter the first security passage and displace said one pin to a cleared position;
(h) a second security actuator sized and shaped to enter the second security passage and displace said another pin to a cleared position;
(i) whereby when the key is fully engaged in the keyway and both security actuators have displaced their respective pins to the cleared position, the key can rotate the plug and thereby displace the latch.

7. A lock system for mounting to a security compartment having an access door, comprising:
(a) cylinder having an outer shell with front and back ends, a plug disposed longitudinally within the shell and selectively rotatable within shell, a keyhole at the front end leading into a keyway that extends longitudinally into the plug, and a plurality of radially displaceable pins, each having a radially outward locking position and a radially inward cleared position, whereby when all pins are in the cleared position the plug is free to rotate within the shell but when at least one pin is in the locking position the plug is prevented from rotating relative to the shell;
(b) a key having a bow for holding in the fingers and a shank extending from the bow, the shank sized and shaped to pass through the keyhhole into the keyway, and having formations thereon for contacting a subset of the pins in the cylinder, to displace said subset from the locking to the cleared position as the key fully engages the keyway;
(c) a latch operatively connected to the plug such that when the plug rotates relative to the shell, the latch is displaced between a latching position for engaging a hook within the compartment, and an unlatching position for disengaging from the hook;
(d) means for mounting the cylinder to the compartment so that the front end of the cylinder is outside the compartment and the back end of the cylinder and the latch are inside the compartment;
(e) a first security passage radially penetrating the shell inside the compartment and leading to one of said pins that is not in the subset engagable by the key formations;
(f) a second security passage into said shell and leading to another of said pins that is not in the subset engagable by the key formations;
(g) a first security actuator sized and shaped to enter the first security passage and displace said one pin to an cleared position;
(h) a second security actuator sized and shaped to enter the second security passage and displace said another pin to an cleared position;
(i) whereby when the key is fully engaged in the keyway and both security actuators have displaced their respective pins to the cleared position, the key can rotate the plug and thereby displace the latch.

8. The lock system of claim 7, wherein the second securities passage is accessible from outside the compartment.

9. The lock system of claim 7, wherein the second security passage is a channel cut in the shank of the key and accessible through the keyhole and the second security actuator is an elongated rod that mates with the sidewalls of the channel for longitudinal displacement into the plug.

10. The lock system of claim 7, wherein the first security actuator is a solenoid.

11. The lock system of claim 7, wherein the cylinder has a third security passage penetrating the shell within the compartment and leading to a third one of said pins that is not in the subset engagable by the key.

12. The lock system of claim 10, wherein the cylinder has a fourth security passage into said shell and leading to a fourth of said pins that is not in the subset engagable by the key bits.

13. The lock system of claim 10, wherein
(i) the fourth of said pins that is not in the subset engageable by the key, is situated adjacent the front of the cylinder,
(ii) the fourth security passage is accessible through the keyhole, and
(iii) the fourth security actuator is mounted on a cup that fits over the keyhole such that the fourth security actuator enters the keyhole and displaces said fourth of said pins when the cup is fully seated over the keyhole.
